(19) United States
(12) Patent Application Publication
(10) Pub. No.: US 2019/0136792 A1
(43) Pub. Date: May 9, 2019

(54) BIMETALLIC PISTON HEADS INCLUDING THERMAL INSULATION COATINGS

(71) Applicant: GM GLOBAL TECHNOLOGY OPERATIONS LLC, Detroit, MI (US)

(72) Inventors: Giancarlo Cifali, Turin (IT); Michele Dematteis, Pinerolo (To) (IT); Francesco Concetto Pesce, Turin (IT)

(21) Appl. No.: 15/807,698

(22) Filed: Nov. 9, 2017

(51) Int. Cl. F02F 3/14; F02F 3/00

(52) U.S. Cl. CPC F02F 3/14; F02F 2003/0061; F02F 3/003; F02F 3/0084

(57) ABSTRACT

Pistons and engines incorporating the same are provided, and include a piston head defined by a top surface, a circumferential side surface, and a thermal insulation coating (TIC) applied to at least a portion of the top surface. A top portion defines the top surface and is made from an aluminum material, and a bottom portion is made from ferrous material. The TIC can be silica. The top surface of the piston head can be anodized to receive the TIC. The TIC can be 0.05 millimeters to about 0.15 millimeters thick. The piston head can includes a crown, having an annular surface defining the top surface, a crown bowl surface, and an inner circumferential surface. The TIC can be further applied to at least a portion of one or more of the crown bowl surface and the inner crown circumferential surface.

### INTRODUCTION

During a combustion cycle of an internal combustion engine (ICE), air/fuel mixtures are provided to cylinders within an engine block of the ICE. The air/fuel mixtures are compressed and/or ignited and combusted to provide output torque via reciprocating pistons positioned within the cylinders.

### SUMMARY

According to an aspect of an exemplary embodiment, a piston for an internal combustion engine is provided. The piston can include a piston head defined by a top surface, a circumferential side surface, a bottom cavity, and a thermal insulation coating (TIC) applied to at least a portion of the top surface. The piston head also includes a top portion which defines the top surface and is made from an aluminum material, and a bottom portion which forms the remainder of the piston head and is made from a ferrous material. The top portion and the bottom portion can be joined by welding. The TIC can be silica. The top surface of the piston head can be anodized prior to application of the TIC. The TIC can have a thickness of about 0.05 millimeters to about 0.15 millimeters. The piston head includes a crown, defined by an annular surface extending inward from the circumferential surface and defining the piston head top surface, a crown bowl surface, and an inner crown circumferential surface extending between an inner edge of the annular surface and an outer periphery of the crown bowl surface. The crown bowl surface can be convex. The TIC can be further applied to at least a portion of one or more of the crown bowl surface and the inner crown circumferential surface. The circumferential side surface can include one or more circumferential piston ring grooves.

According to an aspect of an exemplary embodiment, an internal combustion engine is provided. The engine can include a cylinder block defining one or more cylinder bores, one or more pistons corresponding to each of the one or more cylinder bores and configured to reciprocate therein. Each piston can include a piston head defined by a top crown, a circumferential side surface, a bottom cavity, and a thermal insulation coating (TIC) applied to at least a portion of the annular surface. The top crown can be defined by an annular surface extending inward from the circumferential surface and defining the piston head top surface, a crown bowl surface, and an inner crown circumferential surface extending between an inner edge of the annular surface and an outer periphery of the crown bowl surface. The piston head includes a top portion which defines the top surface and comprises an aluminum material, and a bottom portion forming the remainder of the piston head and comprises a ferrous material. The top portion and the bottom portion of each piston head can be joined by welding. The TIC of each piston head can be silica. The top surface of the piston head can be anodized prior to application of the TIC. The TIC can have a thickness of about 0.05 millimeters to about 0.15 millimeters. The TIC can be further applied to at least a portion of one or more of the crown bowl surface and the inner crown circumferential surface. The top portion can be configured such that the top portion defines each portion of crown to which the TIC is applied. The TIC can be further applied to at least a portion of the crown bowl surface and the inner crown circumferential surface.

Other objects, advantages and novel features of the exemplary embodiments will become more apparent from the following detailed description of exemplary embodiments and the accompanying drawings.

### BRIEF DESCRIPTION OF THE DRAWINGS

FIG. 1 illustrates a side view of an engine, according to one or more embodiments;

FIG. 2A illustrates a cross-sectional side view of a piston head, according to one or more embodiments;

FIG. 2B illustrates a cross-sectional side view of a piston head, according to one or more embodiments;

FIG. 2C illustrates a cross-sectional side view of a piston head, according to one or more embodiments; and

FIG. 2D illustrates a cross-sectional side view of a piston head, according to one or more embodiments.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Provided herein are bimetallic pistons, and engines incorporating the same, comprising thermal insulation coatings (TIC). Specifically, pistons comprising pistons heads having an upper aluminum portion and a lower ferrous portion provided enhanced mechanical benefits while minimizing undesired heat transfer. The aluminum top portions are compatible with various TICs, for example silica TICs.

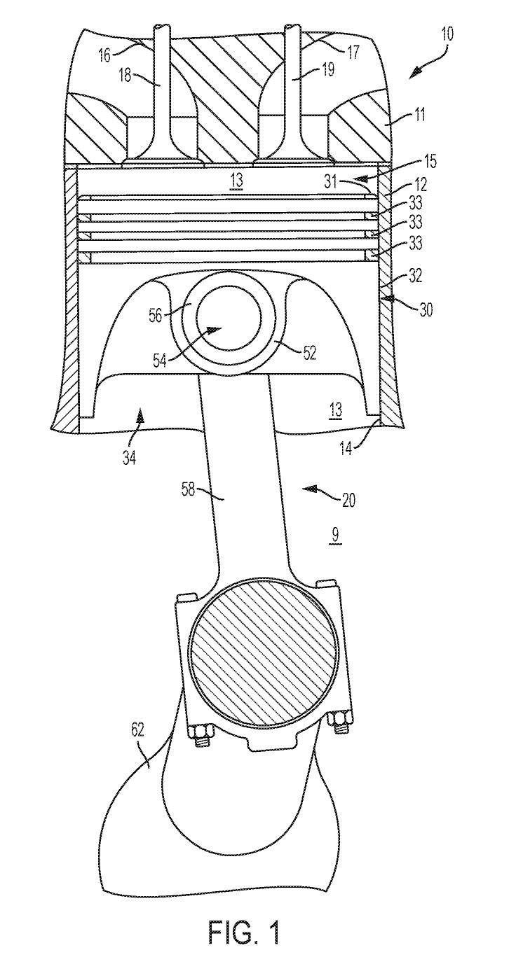

Referring to FIG. 1 of the drawings, there is shown an internal combustion engine including a cylinder case 12 defining a plurality of cylinder bores 13, each cylinder bore 13 having ,generally cylindrical walls 14. Only one cylinder bore 13 is shown and described for the purpose of clarity. Closing one end of the cylinder bore 13 is a cylinder head 11, which cooperates with a top surface 31 of a piston 20 to define a variable volume combustion chamber 15. The cylinder head 11 defines intake and exhaust ports 16 and 17, which are selectively opened by valves, such as poppet valves 18 and 19, respectively. The intake and exhaust ports 16 and 17 are provided in selective communication with the combustion chamber 15 to provide for the introduction of air or an air-fuel mixture into the combustion chamber 15 and the exhaust of products of combustion from the combustion chamber 15.

Piston head 30 is defined by the top surface 31 and a circumferential side surface 32. Circumferential side surface 32 extends downward from top surface 31 and generally defines the cylindrical piston head 30. Piston head 30 may be non-cylindrical in some embodiments, so long as the top surface 31 generally corresponds to the cross sectional geometry of the cylinder bore 13. Piston head 30 can optionally include one or a plurality of circumferential axially spaced piston ring grooves 33 may optionally extend inward from the circumferential side surface, said piston ring grooves being configured to receive a piston ring (not shown). Piston rings can be utilized for one or more a sealing, the combustion chamber 15, controlling oil migration within the cylinder bore 13, and preventing the escape of pressurized gases to a crankcase 9. Piston head 30 can optionally further include a bottom cavity 34. Piston head 30 can further include a pin boss portion 52 which extends downward from top surface 31 for disposition within bottom cavity 34.

Piston 20 is configured for slidable reciprocating motion within the cylinder bore 13. Circumferential side surface 32 is engageable with cylinder wall 14 to guide piston 20 in its reciprocating motion and to absorb thrust forces that may be imposed upon piston 20 by the cylinder wall 14. The top surface 31 forms one wall a the combustion chamber 15 that, upon movement of the piston 20, causes the expansion or contraction of the combustion chamber 15 as is required for operation in an internal combustion engine working cycle. To utilize piston 20 as a means for developing power, piston 20 is operatively engaged with external elements, such as a crankshaft 62 of a vehicle. Crankshaft 62 can translate reciprocating movement of one or more pistons 20 to rotational motion and translate the latter to one or more wheels of a vehicle drivetrain, for example. Crankshaft 62 can be operatively coupled to one or more pistons 20 via one or more respective connecting rods 58; each connecting rod 58 can couple to a piston pin bore 54 of a pin boss 52 via a piston pin 56, for example. In some embodiments, piston pin bore 54 can be formed in one or more places through the circumferential side surface 32. In such an embodiment, the pin boss 52 can be an optional feature.

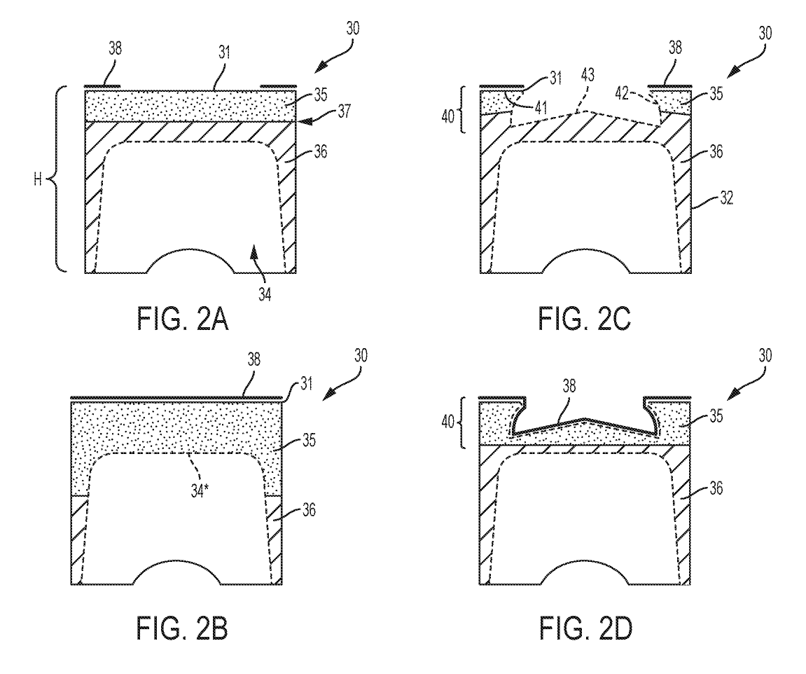

FIGS. 2A-D illustrate cross-sectional side views of piston head 30. Piston head 30 includes a top portion 35 which defines top surface 31 and comprises aluminum, a bottom portion 36 which comprises a ferrous material, and a thermal insulation coating (TIC) 38 which is applied to at least a portion of top surface 31. Piston head 30 is shown in FIGS. 2A-D without some features such as pin boss portion 52 and one or more ring grooves 33 for the non-limiting purpose of clarity, and it is understood that one or more ring grooves 33 may be present within a top portion 35 and/or a bottom portion 36 of piston head 30. Piston head 30 advantageously enjoys the robust mechanical properties of the ferrous bottom portion 36 and the weight-saving aspects of the aluminum top portion 35 by virtue of its two-part construction. Aluminum top portion 35 further lends material compatibility aspects with regards to the TIC 38 deposited thereon. During operation of engine 10, it is desired to maximize thermal energy maintained within or proximate each combustion chamber 15. TIC 38 reduces, minimizes, or otherwise prevents heat transfer from each combustion chamber 15 to its appurtenant piston 20. TIC 38 is applied to a least a portion of the top surface 31. FIG. 2A illustrates an embodiment in which TIC 38 is applied to the outer, radial portion of top surface 31. FIG. 2B illustrates an embodiment in which TIC 38 is applied to the entire top surface 31. In other embodiments, TIC 38 can be applied in different amounts and/or positions upon top surface 31, such as to optimize heat-shielding aspects. For example, high temperature zones of top surface 31 can be identified and TIC 38 can be applied thereat. In some embodiments, the thickness of TIC 38 can vary based upon portions of top surface 31 which absorb more heat during operation of engine 10.

Top portion 35 defines the top surface 31. In some embodiments, top portion 35 defines the top surface 31 upon which the TIC 38 is applied. Thereafter, top portion 35 and bottom portion 36 can vary relative to a height H of piston head 30. FIG. 2A illustrates an embodiment in which bottom portion 36 extends above the bottom cavity 34. FIG. 2B illustrates an embodiment in which bottom portion 36 comprises only regions of piston head 30 which are below the bottom cavity top 34*. The height H variation of top portion 35 and bottom portion 36 can he determined based on various considerations, such as desired piston head 30 mechanical properties and weight, for example, among others.

Top portion 35 comprises aluminum, or a suitable aluminum alloy as are known in the art. In one embodiment, top portion 35 comprises an aluminum-silicon alloy. An aluminum-silicon alloy can comprise up to about 30% silicon, or about 5% to about 25% silicon. In one embodiment, an aluminum-silicon alloy can comprises a eutectic alloy having about 12% silicon, and optionally about 1% each of one or more of copper, nickel and magnesium. In some embodiments, top portion 35 comprises a hyper-eutectic aluminum-silicon alloy having about 17% to about 25% silicon. Top portion 35 can be cast or forged, for example. Bottom portion 36 comprises a ferrous material, such as cast iron, steel, stainless steel, or steel alloys as are known in the art. Some examples of suitable steel alloys include 38MnSiVS5, 42CrMo4, and 38MnVS6, among others. Top portion 35 and bottom portion 36 can be joined at an interface 37 by various suitable methods. In some embodiments, top portion 35 and bottom portion 36 can he joined by welding. Aluminum top portion 35 and ferrous bottom portion 36 can be welded using bimetallic transition inserts, for example. In other embodiments, aluminum top portion 35 and ferrous bottom portion 36 can be welded by dip coating or brazing. In some embodiments, top portion 35 and bottom portion 36 can be joined by mechanical means such as screws or bolts. In some embodiments, top portion 35 comprises a sheath which is disposed about bottom portion 36, such as by compression fitting, for example.

In some embodiments, as shown in FIGS. 2C-D, piston head 30 comprises a crown 40. Crown 40 is generally defined by an annular surface 41 extending inward from the circumferential side surface 32. Annular surface 41 comprises the piston head 30 top surface 31. Although annular surface 41 is pictorially described In FIGS. 2C-D as being generally flat, it is understood that the annular surface may include non-planar contours or features as desired. Further, annular surface 41 is illustrated as extending radially (i.e., perpendicularly) inward, but in other embodiments annular surface 41 can extend inward at a non-perpendicular angle, as desired. Crown 40 further comprises a crown bowl surface 43 and an inner crown circumferential surface 42 extending between an inner edge of the annular surface 41 and an outer periphery of the crown bowl surface 42. In some embodiments, crown bowl surface 43 can be flat (i.e., substantially parallel with top surface 31). In some embodiments, as shown in FIGS. 2C-D, crown bowl surface 43 can be convex. In some embodiments, crown bowl surface 43 can be concave. TIC 38 can be applied to various areas of a crown 40. FIG. 2C illustrates TIC 38 applied to the annular surface 41 of crown 40. In such embodiments, TIC 38 can be applied to the entire annular surface 41 of crown 40. In other embodiments, such as shown in FIG. 2D, TIC 38 can be further applied to the inner crown circumferential surface 42 and/or the crown bowl surface 43. Top portion 35 is configured such that top portion 35 defines each portion of crown 40 to which TIC 38 is applied. For example, as illustrated in FIG. 2C, wherein TIC 38 is applied only to annular surface 41 and not inner crown circumferential surface 42 or crown bowl surface 43, bottom portion 36 can extend above at least a portion of the crown bowl surface 43. In another example, as illustrated in FIG. 2D, wherein TIC 38 is applied to annular surface 41, inner crown circumferential surface 42, and crown bowl surface 43, bottom portion 36 does not extend above the crown bowl surface 43.

Suitable TIC 38 includes those which exhibit suitable heat-shielding performance and are compatible with aluminum top portion 35 such that TIC 38 exhibits suitable bonding when applied thereto. In one embodiment, TIC 38 comprises silica (SiO₂). [Are there any other suitable aluminum-compatible TICS which might be good alternatives to silica.?] A silica TIC 38 can be applied to the top surface 31 of top portion 35 by treating top surface 31 to form a high porosity aluminum oxide surface. The high porosity aluminum oxide surface can be about 50 microns to about 150 microns thick, about 70 microns to about 120 microns thick, or about 80 microns to about 100 microns thick. In a specific example, the high porosity aluminum oxide surface is about 90 microns thick. Top surface 31 can be treated to form porous aluminum oxide by anodizing, for example. Silica can thereafter be applied to, or otherwise formed upon, top surface 31. For example, in one embodiment, top surface 31 can be exposed to a heated solution of comprising alcohol and sodium silicate. In one embodiment, top surface 31 can be exposed to perhydropolysilazane which forms a silica layer thereon upon reacting with water vapor. In another embodiment, top surface 31 can be exposed to a heated solution of dibutyl ether (90-99% by weight) and perhydropolysilazane (1-10% by weight). The TIC 38 layer can vary in thickness based upon the desired insulating characteristics, and TIC 38 bonding capabilities. In some embodiments, TIC 38 comprises a thickness of up to about 0.1 millimeters, up to about 0.125 millimeters, or up to about 0.15 millimeters. In some embodiments TIC 38 comprises a thickness of about 0.05 millimeters to about 0.15 millimeters.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

1. A piston for an internal combustion engine, comprising:
a piston head defined by:
a top surface;
a circumferential side surface;
a bottom cavity; and
a thermal insulation coating (TIC) applied to at least a portion of the top surface,
wherein the piston head comprises a top portion which defines the top surface and comprises an aluminum-silicon alloy, and a bottom portion which forms the remainder of the piston head and comprises a ferrous material.

2. The piston of claim 1, wherein the top portion and the bottom portion are joined by welding.

3. The piston of claim 1, wherein the TIC comprises silica.

4. The piston of claim 3, wherein the top surface of the piston head is anodized prior to application of the TIC.

5. The piston of claim 3, wherein the TIC comprises a thickness of about 0.05 millimeters to about 0.15 millimeters.

6. The piston of claim 1, wherein the piston head comprises a crown, defined by an annular surface extending inward from the circumferential side surface and defining the piston head top surface, a crown bowl surface, and an inner crown circumferential surface extending between an inner edge of the annular surface and an outer periphery of the crown bowl surface.

7. The piston of claim 6, wherein the crown bowl surface is convex.

8. The piston of claim 6, wherein the TIC is further applied to at least a portion of one or more of the crown bowl surface and the inner crown circumferential surface.

9. The piston of claim 1, wherein the circumferential side surface comprises one or more circumferential piston ring grooves.

10. An internal combustion engine, comprising:
a cylinder block defining one or more cylinder bores; and
one or more pistons corresponding to each of the one or more cylinder bores and configured to reciprocate therein, wherein each piston comprises:
a piston head defined by:
a circumferential side surface;
a top crown defined by:
an annular surface extending inward from the circumferential side surface and defining a piston head top surface,
a crown bowl surface, and
an inner crown circumferential surface extending between an inner edge of the annular surface and an outer periphery of the crown bowl surface,
a bottom cavity; and
a thermal insulation coating (TIC) applied to at least a portion of the annular surface,
wherein the piston head comprises a top portion which defines the top surface and comprises an aluminum-silicon alloy, and a bottom portion forming the remainder of the piston head and comprises a ferrous material.

11. The internal combustion engine of claim 10, wherein the top portion and the bottom portion of each piston head are joined by welding.

12. The internal combustion engine of claim 10, wherein the TIC of each piston head comprises silica.

13. The internal combustion engine of claim 12, wherein the top surface of the piston head is anodized prior to application of the TIC.

14. The internal combustion engine of claim 12, wherein the TIC comprises a thickness of about 0.05 millimeters to about 0.15 millimeters.

15. The internal combustion engine of claim 10, wherein the TIC is further applied to at least a portion of one or more of the crown bowl surface and the inner crown circumferential surface.

16. The internal combustion engine of claim 10, wherein the top portion is configured such that the top portion defines each portion of crown to which the TIC is applied.

17. The internal combustion engine of claim 10, wherein the TIC is further applied to at least a portion of the crown bowl surface and the inner crown circumferential surface.
